(19) United States
(12) Patent Application Publication
(10) Pub. No.: US 2007/0227059 A1
(43) Pub. Date: Oct. 4, 2007

(54) FISHING TACKLE COUPLING SYSTEM AND METHOD

(76) Inventors: Darryl L. Cox, Chehalis, WA (US); Doug B. Coleman, Chehalis, WA (US); James M. Moyer, Chehalis, WA (US)

Correspondence Address: DAVIS WRIGHT TREMAINE, LLP, 1201 Third Avenue, Suite 2200, SEATTLE, WA, 98101-3045, US

(21) Appl. No.: 11/277,925

(22) Filed: Mar. 29, 2006

(51) Int. Cl. A01K 91/04; A01K 91/03; A01K 91/047

(52) U.S. Cl. 43/25.2; 43/44.87; 43/42.49; 43/43.1

(57) ABSTRACT

As discussed herein, a fishing tackle coupling system uses various combinations of couplers and crimpable connectors to help secure fishing hooks, lures, and other tetherable tackle objects to a fishing line. The couplers can allow for rapid replacement or exchange of tetherable tackle objects previously coupled to a fishing line.

### BACKGROUND OF THE INVENTION

1. Field of the Invention

The present invention is generally related to fishing equipment, and more particularly related to fishing tackle.

2. Description of the Related Art

Fishing is a recreational sport that can involve a wide range of people and family members. Unfortunately, more could participate if a few aspects of the sport could be improved upon. For instance, attaching lures and fishhooks to fishing lines can be an unpleasant challenge for the occasional participant who has neither the time, access to training, or the inclination to fully learn how to quickly and efficiently tie an acceptable fishing knot.

Consequently, fish can get away due to improperly fastened hooks and lures, children's patience can be tried while their parents agonize over such a seemingly simple procedure as tying a knot, injury can occur due to unsecured hooks and lures, and opportunities can be missed due to an inability to quickly change hooks or lures to adapt to changing fishing conditions.

### BRIEF DESCRIPTION OF THE SEVERAL VIEWS OF THE DRAWING(S)

FIG. 1 is a side elevational view of a fishing rod with a tackle retainer system and a first implementation of a fishing tackle coupling system having a first rod-end combination coupled to a first object-end combination.

FIG. 2 is an enlarged side elevational view of a portion of the fishing rod shown in FIG. 1 showing detail of the fishing tackle coupling system.

FIG. 3 is a side elevational view of the fishing rod with the first implementation of the coupling system of FIG. 1 having the first rod-end combination and the first object-end combination shown coupled together in FIG. 1 now both coupled to the tackle retainer system.

FIG. 4 is an enlarged side elevational view of a portion of the fishing rod shown in FIG. 3 showing detail of the tackle retainer system.

FIG. 5 is a side elevational view of the first implementation of the coupling system with the first rod-end combination and the first object-end combination, shown in FIG. 1, uncoupled from one another.

FIG. 6 is a side elevational view of a second implementation of the coupling system with a second rod-end combination and the first object-end combination uncoupled from one another.

FIG. 7 is a side elevational view of a third implementation of the coupling system with the first rod-end combination and a second object-end combination uncoupled from one another.

FIG. 8 is a side elevational view of a fourth implementation of the coupling system with the first rod-end combination and a third object-end combination uncoupled from one another.

FIG. 9 is a side elevational cross sectional view of a crimpable connector used in implementations of the coupling system showing operational detail prior to a first pass of a fishing line through the crimpable connector.

FIG. 10 is a side elevational cross sectional view of the crimpable connector shown in FIG. 9 after the first pass of the fishing line through the crimpable connector and prior to a pass through the eyelet of a threaded coupler.

FIG. 11 is a side elevational cross sectional view of the crimpable connector shown in FIG. 10 after the first pass of the fishing line through the crimpable connector and the pass through the eyelet of the threaded coupler.

FIG. 12 is a side elevational cross sectional view of the crimpable connector shown in FIG. 11 after the second pass of the fishing line through the crimpable connector and prior to crimping of the crimpable connector.

FIG. 13 is a side elevational cross sectional view of the crimpable connector shown in FIG. 12 after the second pass of the fishing line through the crimpable connector and after crimping of the crimpable connector.

FIG. 14 is a cross-sectional view of a crimpable connector prior to crimping of the crimpable connector.

FIG. 15 is a cross-sectional view of the crimpable connector of FIG. 14 subsequent to crimping of the crimpable connector.

FIG. 16 is a cross-sectional view of the first rod-end combination and second object-end combination uncoupled from one another.

FIG. 17 is a cross-sectional view of the first rod-end combination and second object-end combination coupled to one another.

FIG. 18 is a side elevational view of a partial turn coupler showing uncoupled portions.

FIG. 19 is a side elevational view of the partial turn coupler of FIG. 18 showing coupled portions.

FIG. 20 is a side elevational view of a straight-insert coupler showing uncoupled portions.

FIG. 21 is a side elevational view of the straight-insert coupler showing coupled portions.

FIG. 22 is a side elevational view of a fifth implementation of the coupling system.

### DETAILED DESCRIPTION OF THE INVENTION

As discussed herein, a fishing tackle coupling system uses various combinations of couplers and crimpable connectors to help secure fishing hooks, lures, and other tetherable tackle objects to a fishing line. Through use of the coupling system, the need for knot tying to secure tetherable tackle objects such as fishhooks and/or lures to fishing lines is reduced or eliminated.

The couplers also allow for rapid replacement or exchange of tetherable tackle objects previously coupled to a fishing line. The capability for rapid replacement or exchange of tetherable tackle objects helps an end user to fish with tetherable tackle objects that are well maintained and suitable for the conditions at hand. Further associated with the coupling system, a tackle retainer system for use with a fishing rod is able to secure a collection of tetherable tackle objects for ready access in case replacement or exchange of a tetherable tackle object in use is needed.

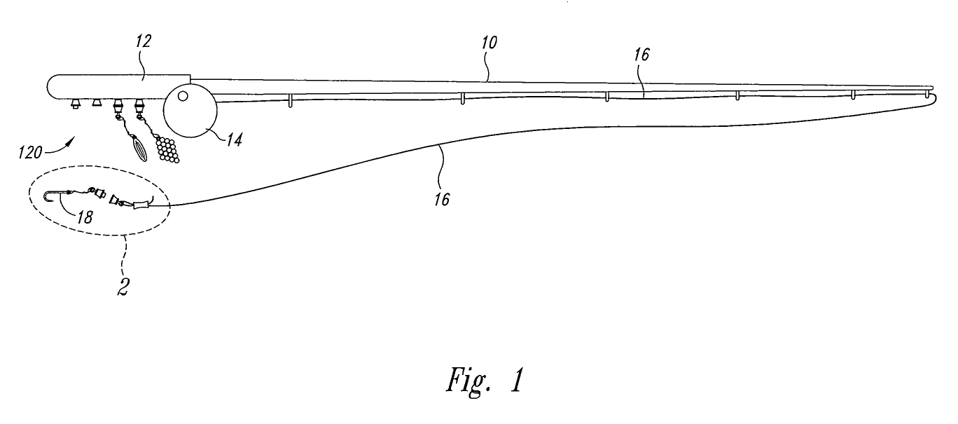

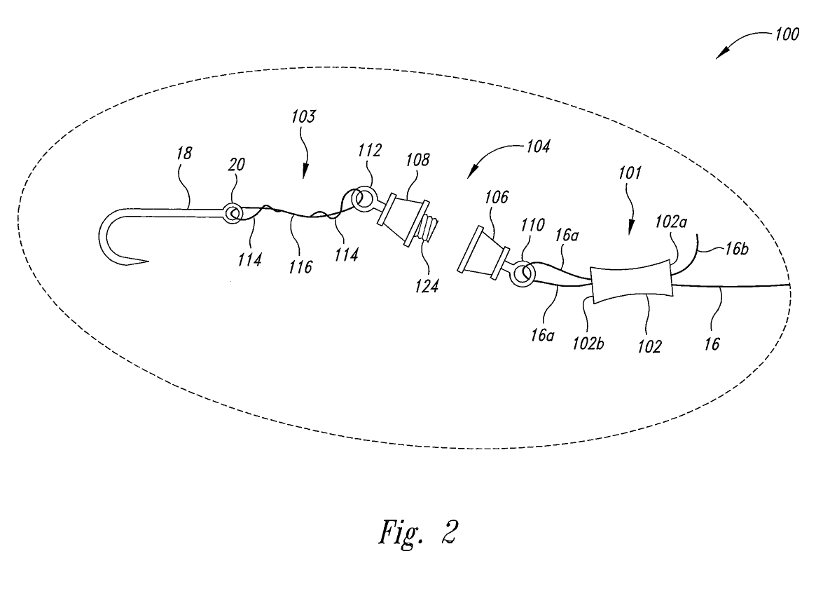

A fishing rod 10 with a handle 12, a reel 14 affixed thereto the handle, and a fishing line 16 unreeled therefrom the reel is shown in FIG. 1. The fishing line 16 is coupled to a tetherable tackle object 18 exemplary depicted in FIG. 1 as a fishhook. A first implementation 100 of a fishing tackle coupling system, better shown in FIG. 2, has a first rod-end combination 101 that includes a crimpable connector 102 through which the fishing line 16 makes a first pass 16a from rod-side 102a of the crimpable connector on through past object-side 102b of the crimpable connector. The first implementation 100 further includes a first object-end combination 103. The first rod-end combination 101 is couplable to the first object-end combination 103 by way of a coupler 104, which has a receiver portion 106 and an insert portion 108 disengageably couplable with each other.

The receiver portion 106 has an eyelet 110 through which the fishing line 16 is threaded on the first pass 16a from the object-side 102b of the crimpable connector 102 as part of fixedly attaching the receiver portion to the first rod-end combination 101. The eyelet 110 can be swivelably coupled to the remainder of the receiver portion 106. Furthermore, the fishing line 16 is further threaded back from the object-side 102b on a second pass 16b through the crimpable connector 102 on through past the rod-side 102a. To complete the fixed attachment of the receiver portion 106 of the coupler 104 with the first rod-end combination 101, the crimpable connector 102 is crimped down upon the first pass 16a and the second pass 16b of the fishing line 16.

The insert portion 108 has an eyelet 112, which can be swivelably coupled to a remainder of the insert portion. The tetherable tackle object 18 also has an eyelet 20. The first object-end combination 103 of the first implementation 100 is fixedly coupled to the insert portion 108 of the coupler 104 by knots 114 affixed to the eyelet 112 and the eyelet 20 with a support line 116 extending therebetween.

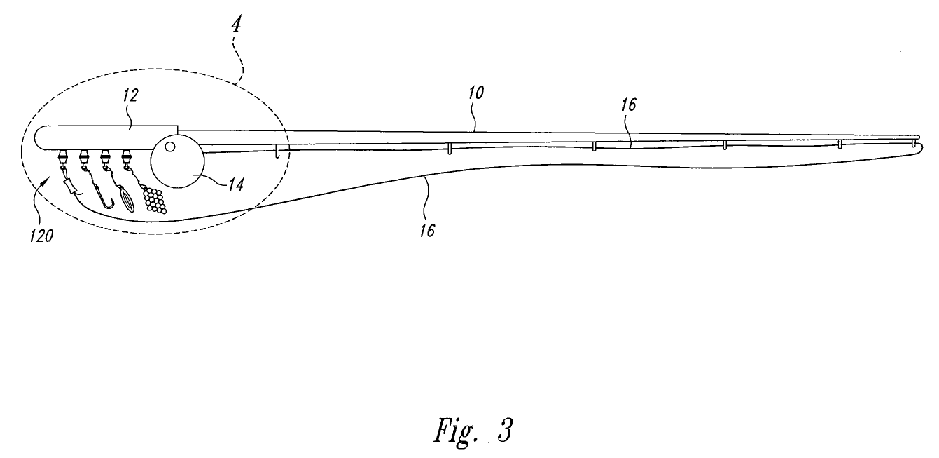

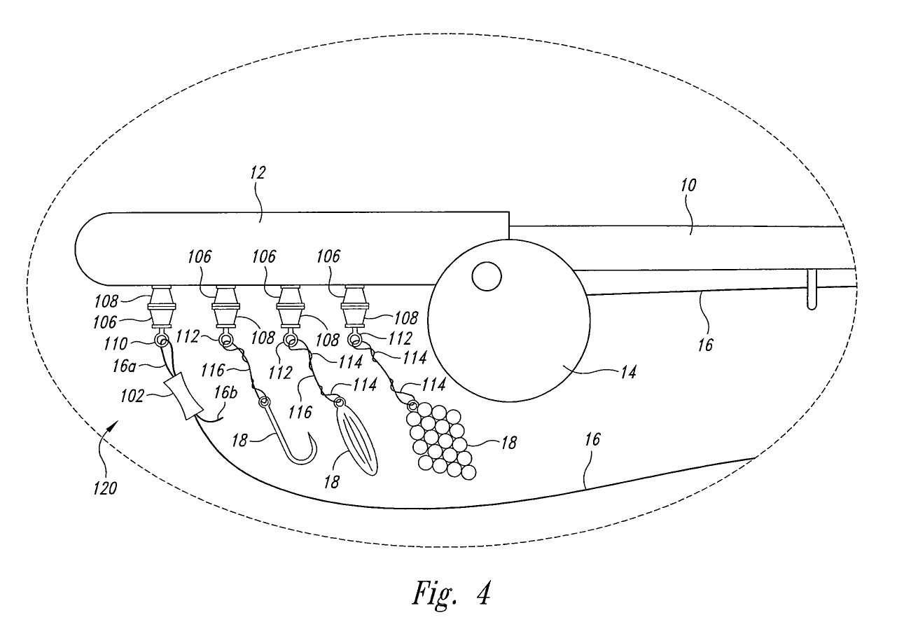

A tackle retainer system 120 is shown in FIG. 3 and FIG. 4 as the handle 12 having instances of the receiver portion 106 and one instance of the insert portion 108 all mounted and affixed to the handle. The receiver portions 106 mounted on the handle 120 are shown coupled to instances of the insert portion 108 of the coupler 104 to retain various instances of the tetherable tackle object 18, including lures and a fishing hook, being each fixedly attached to different of the instances of the insert portion 108. One coupling of the mounted instance of the insert portion 108 and an instance the receiver portion 106 fixedly attached to the fishing line 16 is shown retaining the fishing line. The tackle retainer system 120 affords proximate accessibility of spare tetherable tackle objects 18 to the end user, which can serve to increase usability and enjoyment of the implementations.

The first implementation 100 of the coupling system is shown in FIG. 5 with the receiver portion 106 and the insert portion 108 of the coupler 104 uncoupled from one another. As shown, the first implementation 100 uses an instance of the coupler 104 in which the receiver portion 106 has a threaded receiver 122 and the insert portion 108 has an insert 124 threaded complimentary to the receiver.

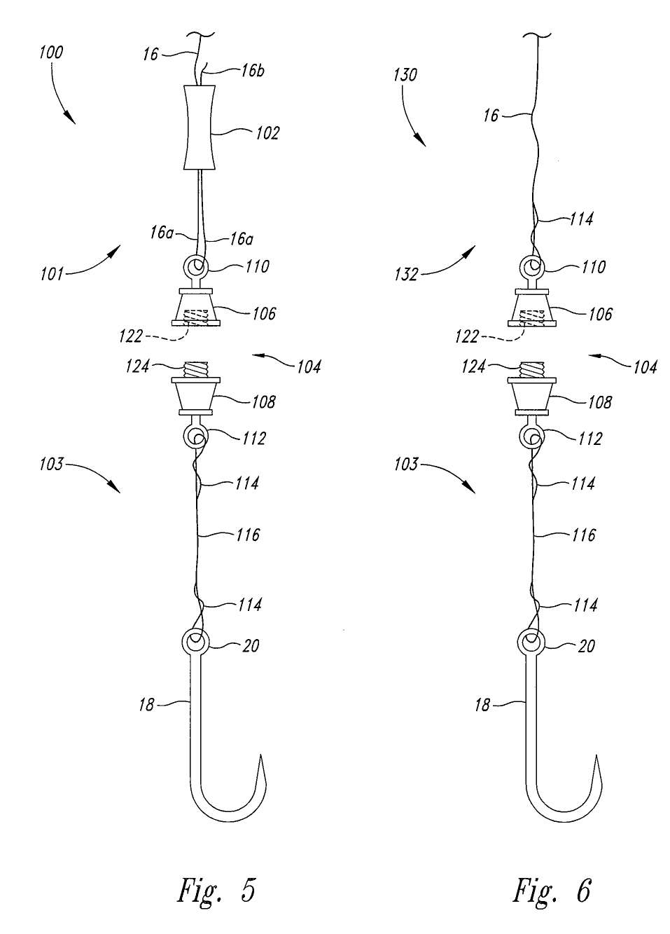

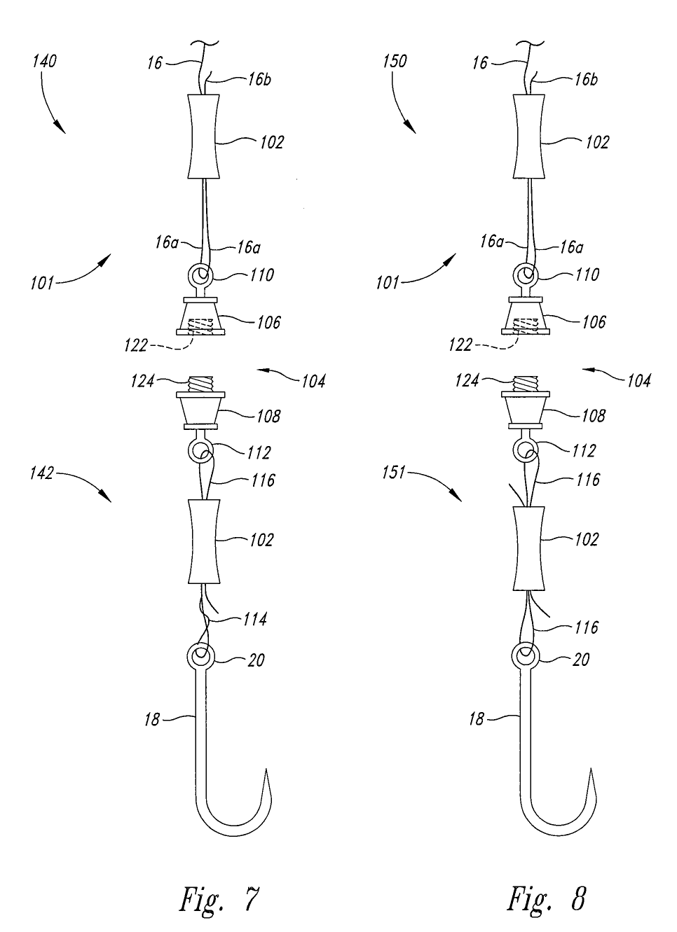

A second implementation 130 of the coupling system is shown in FIG. 6 with the first object-end combination 103 and a second rod-end combination 132, which uses an instance of the knot 114 to couple the fishing line 16 to the eyelet 110 of the receiver portion 106 of the coupler 104.

A third implementation 140 of the coupling system is shown in FIG. 7 with the first rod-end combination 101 and a second object-end combination 142, which couples the support line 116 to the eyelet 20 of the tetherable tackle object 18 with an instance of the knot 114. The second object-end combination 142 couples the support line 116 to the eyelet 112 of the insert portion 108 of the coupler 104 by looping the support line through the eyelet and back through an instance of the crimpable connector 102.

A fourth implementation 150 of the coupling system is shown in FIG. 8 with the first rod-end combination 101 and a third object-end combination 151, which couples the support line 116 to the eyelet 20 of the tetherable tackle object 18 by looping the support line through the eyelet and back through an instance of the crimpable connector 102. The third object-end combination 142 also couples the support line 116 to the eyelet 112 of the insert portion 108 of the coupler 104 by looping the support line through the eyelet and back through the instance of the crimpable connector 102.

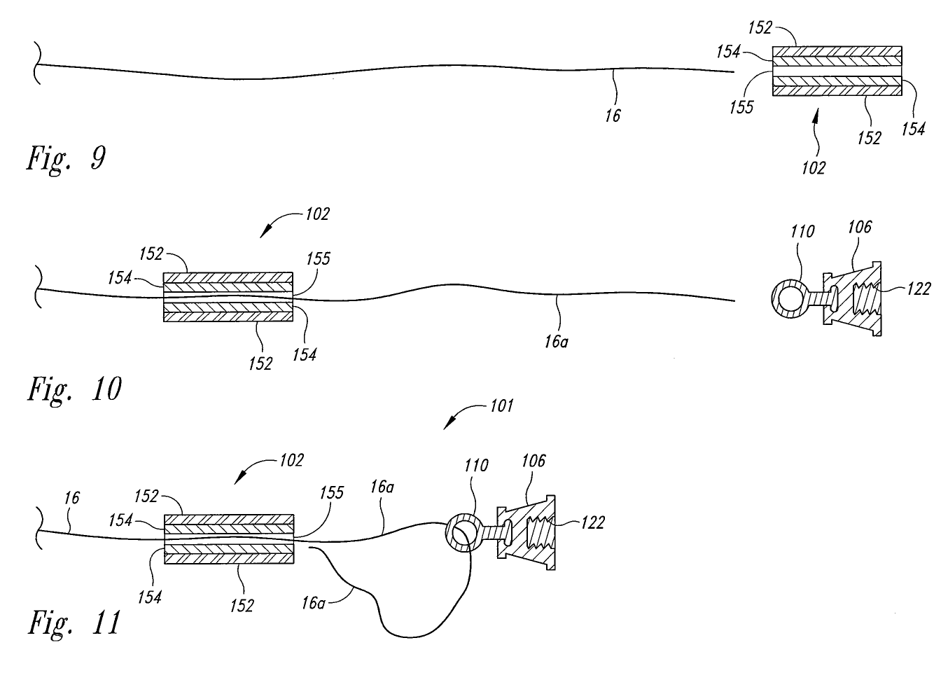

Operational detail regarding the crimpable connector 102 is shown in FIGS. 9-15 as particularly used in the first rod-end combination, but also teaches more general use of the crimpable connector with other combinations. The crimpable connector 102 has an outer layer 152 that can be made of any such crimpable material that inelastically yields to a sufficient external force. Various metal, plastic, other materials, and combinations thereof can exhibit such inelastic yield properties to be candidates for the outer layer 152.

The crimpable connector 102 has an inner layer 154 made from a compressible material such as rubber, neoprene, polymer, foam, plastic, silicone, or other material. Material selection for the inner layer 154 includes consideration that the associated surface coefficient of friction of the selected material be sufficiently large when the inner layer 154 is compressed by crimping of the outer layer 152 so that the crimpable connector 102 will adequately grab and retain the fishing line when crimped.

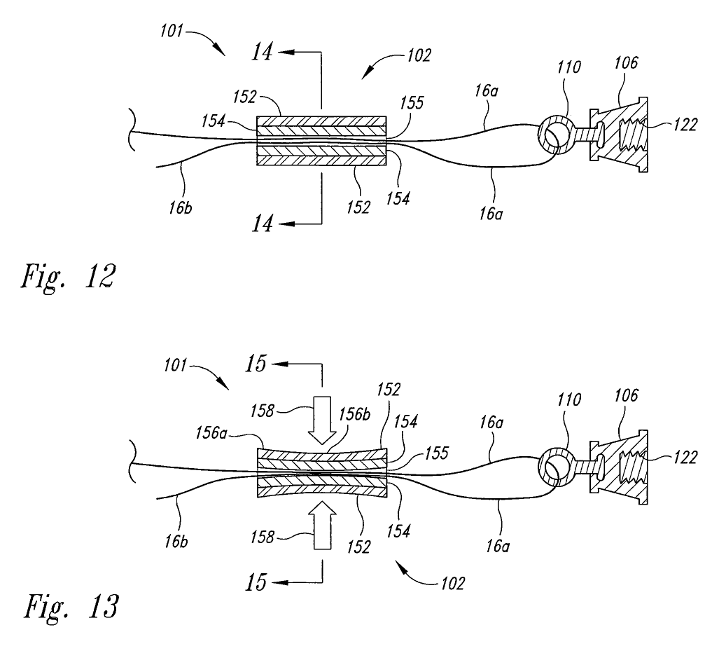

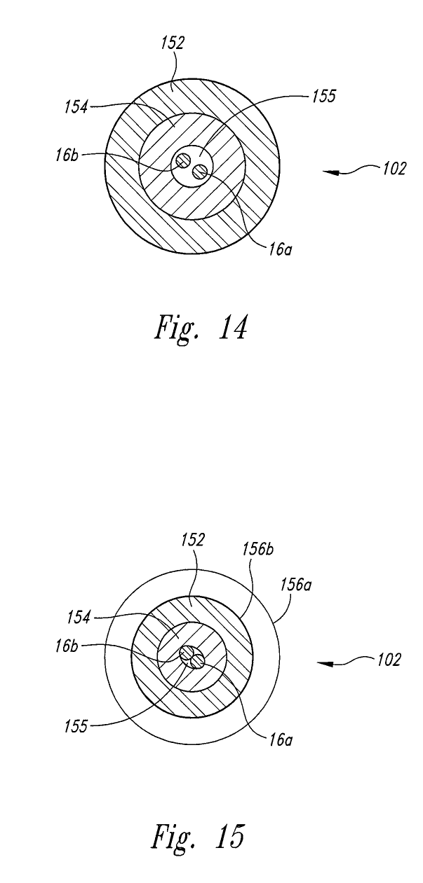

As shown in FIG. 9 and FIG. 10, the fishing line 16 is first inserted through the crimpable connector 102. The fishing line 16 is then looped through the eyelet 110 of the receiver portion 106 of the coupler 104 as shown in FIG. 11. After being looped through the eyelet 110, the fishing line 16 is passed a second time through the crimpable connector 102, as shown in FIGS. 12 and 14, whereupon external force 158 is applied to the crimpable connector to thereby crimp the crimpable connector and thereby fixedly couple the fishing line with the crimpable connector as shown in FIGS. 13 and 15.

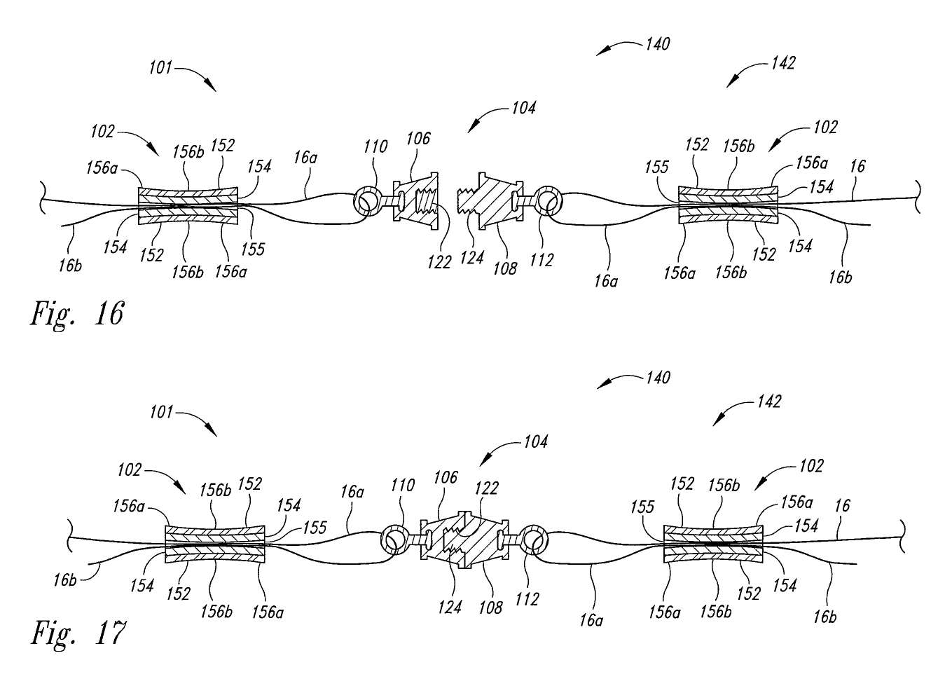

The third implementation 140 is shown in cross section in FIG. 16 with the coupler 104 being uncoupled and in FIG. 17 with the coupler 104 being coupled. Since the third implementation uses two instances of the crimpable connector 102, FIGS. 16 and 17 further show how the crimpable connector 102 is used.

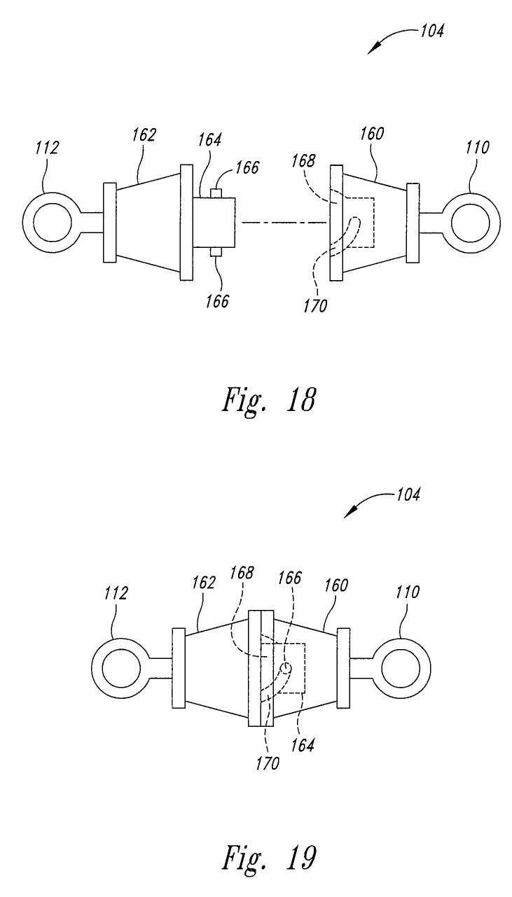

A second implementation of the coupler 104 is shown in FIGS. 18 and 19 with a receiver portion 160 and an insert portion 162, which has an insert 164 with stems 166. The receiver portion 160 has a receiver 168 with channels 170 to accept the stems 166 of the insert 164. The channels 170 are shaped to receive the stems 166 for approximately a quarter turn of the insert portion 162 relative to the receiver portion 160 or other degree of turn, partial or otherwise, so that coupling can possibly be more rapid with the second implementation of the coupler 104 than with the previously discussed implementation of the coupler. Other implementations can have other required amounts of rotation of the insert portion 162 relative to the receiver portion 160 to accomplish coupling.

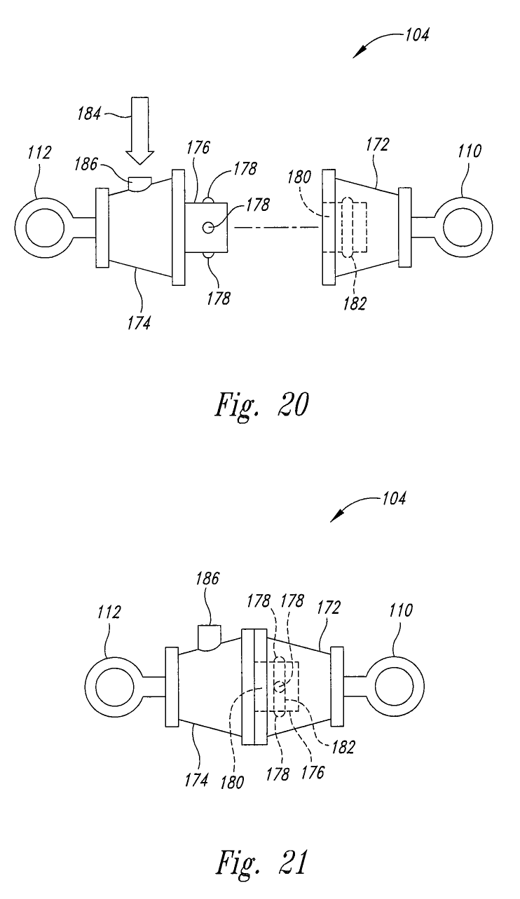

A third implementation of the coupler 104 is shown in FIG. 20 and FIG. 21 with a receiver portion 172 and an insert portion 174, which has an insert 176 with retractable ball bearings 178. The receiver portion 172 has a receiver 180 with a bearing channel 182 to accept the ball bearings 178 of the insert 176. The bearing channel 182 is shaped to receive and retain the ball bearings 178 for coupling of the receiver portion 172 with the insert portion 174. A force 184 is applied to a button 186 of the insert portion 174 to retract the ball bearings 178 for insertion of the insert 176 into the receiver 180. Once the insert 176 is fully inside the receiver 180, the force 184 is removed, as shown in FIG. 21, to extend the ball bearings 178 into the bearing channel 182 for engagement of the insert portion 174 with the receiver portion 172.

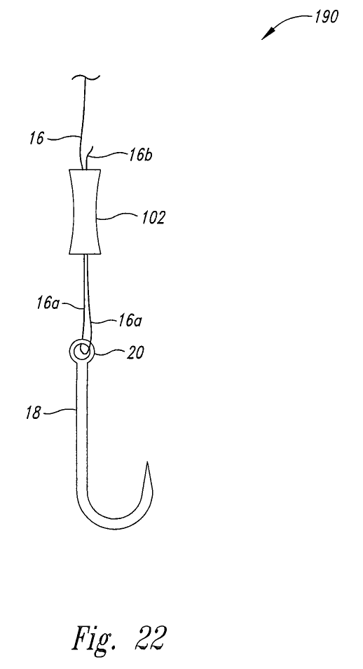

A fifth implementation 190 of the coupling system is shown in FIG. 22 as having the fishing line 16 directly coupled to the tetherable tackle object 18 by looping the fishing line through the eyelet 20 of the tetherable tackle object. The fishing line 16 is secured with an instance of the crimpable connector 102 similar to the first rod-end combination 101 in which, as discussed above, the fishing line is directly coupled to the eyelet 110 of the receiver portion 106 of the coupler 104 and secured with an instance of the crimpable connector.

From the foregoing it will be appreciated that, although specific embodiments of the invention have been described herein for purposes of illustration, various modifications may be made without deviating from the spirit and scope of the invention. For instance, the receiver portion 106 of the coupler 104 was depicted as being coupled to the rod-end combinations, however, in other implementations, the receiver portion could be coupled to the object-end combinations.

As another example, the depicted implementation of the tackle retainer system 120 was shown as an integral part of the handle 12. In other implementations, the tackle retainer system 120 can be a part of other objects such as other objects worn by the end-user, such as a hat, vest, belt, jacket, etc. or other object such as a portion of a chair, a portion of another piece of furniture, a portion of a boat, a portion of a tackle box, etc.

As a further example, various rod-end combinations and object-end combinations were depicted for exemplary purposes, however, other implementations of the coupling system use various other combinations of instances of the crimpable connector 102 and/or the coupler 104 and/or the knot 114. Also, the coupler was depicted in three different implementations, but other implementations of the coupler can be used for both the coupling system and the tackle retaining system. The other coupler implementations will still have a first portion and a second portion that are disengageably couplable with each other and affixedly attached to an implementation of the rod-end combination and an implementation of the object-end combination, respectively.

As an additional example, the crimpable connector 102 was depicted with the outer layer 152 and the inner layer 154 having a tubular shape. In other implementations, the crimpable connector 102 can be of other shapes. For instance, the outer layer 152 and the inner layer 154 could be of a general rectangular shape with an inner passageway for the fishing line 16 or the support line 116 to pass. Other shapes for the outer layer 152 and the inner layer 154 are possible as well provided that a passageway remains for the fishing line 16 or the support line 116 to pass and that the basic functions of the outer layer and the inner layer remain. Accordingly, the invention is not limited except as by the appended claims.

The invention claimed is:

1. For a fishing line, a connector comprising:
a compressible inner layer with an opening; and
a crimpable outer layer covering at least a portion of the inner layer, the opening of the inner layer sized to allow at least two passes of the fishing line through the opening before the outer layer has been crimped, the inner layer having a sufficient compressibility and sufficient surface coefficient of friction to retain the at least two passes of fishing line after the outer layer has been crimped.

2. The connector of claim 1 wherein the inner layer has a compressibility of one of the following materials: rubber, neoprene, polymer, foam, plastic, and silicone.

3. The connector of claim 1 wherein the outer layer is crimpable due to inelastic yield properties of one of the following materials: metal and plastic.

4. For a fishing line having a first fishing line portion and a second fishing line portion, a coupler comprising:
a first coupler portion having a first eyelet, the first eyelet shaped to receive the first fishing line portion for coupling of the first fishing line portion to the first eyelet; and
a second coupler portion having a second eyelet, the second eyelet shaped to receive the second fishing line portion for coupling of the second fishing line portion to the second eyelet, the first coupler portion and the second coupler portion being disengageably couplable with each other.

5. The coupler of claim 4 wherein the first eyelet is swivelably coupled to that portion of the first coupler portion other than the first eyelet and the second eyelet is swivelably coupled to that portion of the second coupler portion other than the second eyelet.

6. The coupler of claim 4 wherein the first coupler portion and the second coupler portion are threadably couplable with each other.

7. The coupler of claim 4 wherein the first coupler portion has at least one stem and the second coupler portion has at least one channel to receive the at least one stem.

8. The coupler of claim 4 wherein the first coupler portion has at least one retractable ball bearing and the second coupler portion has at least one bearing channel to receive the at least one ball bearing.

9. A system for retaining a plurality of tackle objects, the system comprising:
a plurality of mounted first coupler portions; and
a plurality of second coupler portions, each of the second coupler portions coupled to a different one of the plurality of tackle objects, each of the first coupler portions being disengageably couplable with at least one the second coupler portions.

10. The system of claim 9 further comprising a fishing pole, wherein the mounted first coupler portions are mounted to the fishing pole.

11. A system comprising:
a fishing line;
an object having an object opening; and
a connector having a connector opening, the fishing line passing through the connector opening a first pass, the fishing line passing through the object opening, and the fishing line passing through the connector opening a second pass, connector being crimped to frictionally engage with the first pass and the second pass of the fishing line through the connector opening.

12. The system of claim 11 wherein the object is a tetherable tackle object.

13. The system of claim 11 wherein the object is a coupler having a first coupler portion with an eyelet as the object opening and having a second coupler portion disengageably couplable with the first coupler portion.

14. A system comprising:
a fishing line;
an object; and
a coupler having a first coupler portion and a second coupler portion couplable with the first coupler portion, the fishing line coupled to the object and coupled to the first coupler portion.

15. The system of claim 14 wherein the fishing line is knotted to be coupled to the object.

16. The system of claim 14 wherein the object has an opening and the fishing line is coupled to the object by being looped through the opening of the object.

17. The system of claim 14 wherein the object is a tetherable tackle object.

18. The system of claim 14 wherein the object is a connector having a connector opening, the fishing line passing through the connector opening a first pass, the fishing line passing through a portion of the first coupler, and the fishing line passing through the connector opening a second pass, the connector being crimped to frictionally engage with the first pass and the second pass of the fishing line through the connector opening.

19. A method comprising:
passing a fishing line a first pass through an opening in a connector;
passing the fishing line through an opening in an object;
passing the fishing line a second pass through the opening in the connector; and
crimping the connector to engage with the fishing line.

20. The method of claim 19 wherein the object is a tackle object.

21. The method of claim 19 wherein the object is a coupler having a first coupler portion and a second coupler portion being engagable with each other.

22. A method comprising:
coupling a first fishing line portion to a first coupler portion;
coupling the first fishing line portion to an object;
coupling a second fishing line portion to a second coupler portion; and
coupling the first coupler portion to the second coupler portion.

23. The method of claim 22 wherein the object is a tackle object.

24. The method of claim 22 wherein the object is a crimpable connector.

25. The method of claim 22 wherein the coupling the first fishing line portion of the first coupler portion includes passing the fishing line a first pass through a connector, passing the fishing line through an opening in the first coupler portion, passing the fishing line a second pass through the connector, and crimping the connector to engage the connector with the fishing line.

26. The method of claim 22 wherein the coupling the first fishing line portion to the first coupler portion includes tying the fishing line to the first coupler portion.
